(19) United States
(12) Patent Application Publication
(10) Pub. No.: US 2025/0382825 A1
(43) Pub. Date: Dec. 18, 2025

(54) AUTOMOTIVE UNLOCKING TOOL

(71) Applicant: Aurelio Vigil, Miami, FL (US)

(72) Inventor: Aurelio Vigil, Miami, FL (US)

(21) Appl. No.: 18/747,219

(22) Filed: Jun. 18, 2024

(51) Int. Cl. E05B 19/20

(52) U.S. Cl. CPC E05B 19/20

(57) ABSTRACT

A tool designed to manually unlock automotive vehicles with frameless windows including TESLA® vehicles from the outside of the vehicle is described. The tool includes an elongated strip of material having an operator proximate end and terminating at a hook at a distal end, and a control wire, cord, or line operatively connected to the elongated strip of metallic material at the distal end that causes the distal end to bend when pulled at the operator proximate end. A kit and a method featuring the tool are also described.

### FIELD

The present disclosure is directed to the field of automotive tools. More particularly, the present disclosure relates to a tool designed to manually unlock automotive vehicles with frameless windows including a TESLA® vehicle when the key is not available or the 12 volt battery system is dead or inoperative.

### SUMMARY

In general, in a first aspect, the disclosure features a tool designed to manually unlock automotive vehicles with frameless windows including a TESLA® vehicle from control from the outside of the vehicle. The tool includes an elongated strip of material having an operator proximate end and terminating at a hook at a distal end, and a control wire, cord, or line operatively connected to the elongated strip of metallic material at the distal end that causes the distal end to bend when pulled at the operator proximate end.

In general, in a second aspect, the disclosure features a kit including a tool of the disclosure, first and second plastic shields having a thickness dimensioned to fit together with the tool within a space between a glass window and weatherstripping of a door frame of the locked TESLA® vehicle, and optionally written instructions for operating the kit.

In general, in a third aspect, the disclosure features a method of unlocking automotive vehicles with frameless windows including a TESLA® vehicle. The method includes inserting the first and second plastic shields of a kit of the disclosure within the space between the glass window and weatherstripping of the door frame of the locked vehicle, inserting the tool of the kit between the first and second plastic shields such that the distal end of the tool enters inside the vehicle while the operator proximate end remains outside the vehicle, operating the proximate end of the tool to cause the distal end to engage the manual release lever, and pulling the proximate end of the tool to cause the manual release lever to unlatch.

Features of the tool, kit, and method can include the following. The control wire, cord, or line can be operatively connected in a manner such that an operator can cause the distal end of the elongated strip of material to bend toward an opposite side of the elongated strip of material to which the control wire, cord, or line is pulled. The control wire, cord, or line can be threaded through a hole in a midportion of the elongated strip of material such that the control wire, cord, or line crosses over from a first side toward an opposite side of the elongated strip of material. The control wire, cord, or line can terminate at a pair of anchor holes at the distal end of the elongated strip of material before the hook. The control wire, cord, or line can form a loop at the proximate end of the elongated strip of material. Operating the proximate end can include pulling the control wire, cord, or line on a left side of the proximate end of the tool to cause the distal end of tool to bend toward the right, or pulling the control wire, cord, or line on the right side of the proximate end of the tool to cause the distal end of the tool to bend toward the left. The elongated strip of material can have a thickness dimensioned to fit within a space between a glass window and weatherstripping of a door frame of the vehicle. The elongated strip of material can have a length dimensioned to allow a user to operate the proximate end of the elongated strip of material outside a locked vehicle while controlling the distal end to reach the manual door release lever inside the locked vehicle. The elongated strip of material can be made of or include metal or a metal alloy.

It should be understood that the tool, kit, and method are not to be considered limitations on the invention defined by the claims. The featured tool, kit, and method can be implemented in one or more ways using one or more features depicted in the drawings, described in the detailed description, and set forth in the claims.

### BRIEF DESCRIPTION OF THE DRAWINGS

The accompanying drawings illustrate certain aspects and principles of the implementations set forth, and should not be construed as limiting.

FIGS. 1A-1D are diagrams depicting a frameless windows unlocking tool at various perspective views according to one implementation, where FIGS. 1A and 1B represent a top view,

FIG. 1C represents a side view, and FIG. 1D represents an end view.

FIG. 2 is an image showing an end of the unlocking tool that is distal to the handle according to one implementation.

FIG. 3 is an image showing a magnified view of the distal end of the tool according to one implementation.

FIG. 4 is an image showing a unlocking tool with accompanying plastic shields designed to facilitate insertion of the tool according to one implementation.

FIGS. 5-13 are images showing steps in the process of operating the unlocking tool according to one implementation, where FIG. 5 shows a door frame in a locked state, FIG. 6 shows a door frame in an unlocked state, FIGS. 7 and 8 show insertion of the plastic shields between the glass of the window and the weatherstripping, FIGS. 9 and 10 show insertion of the tool tip between the plastic shields, FIG. 11 shows operation of the control wire, line, or cord of the tool to move the hook of the tool into position, and FIGS. 12 and 13 show engagement of the hook at the distal end of the tool to release the release lever to unlock the door.

FIGS. 14 and 15 are tables having written instructions and images as guides for a user to operate the unlocking tool.

### DETAILED DESCRIPTION

Reference will now be made in detail to various illustrative implementations. It is to be understood that the following discussion of the implementations is not intended to be limiting.

This disclosure relates to a tool designed to manually unlock automotive vehicles with frameless windows including TESLA® vehicles by bypassing the electronic lock mechanism and using the vehicle's manual emergency door lock release lever as a method for unlocking the vehicle in situations when the battery is dead, the 12 volt battery system is dead or inoperative, the key is not available or not accessible, in emergency situations such as when a child or a pet is locked in the vehicle, or for road service and or towing operations. The tool is designed to unlock the vehicle by a user outside the vehicle without damage or breakage to the delicate laminate glass window or without damage or alteration of any other vehicle components as the tool allows access to the inside of the vehicle without disturbing the delicate laminate glass. The tool allows manipulation and/or movement of the tip of the tool from the outside of the vehicle in order to engage the emergency lock release lever inside of the vehicle.

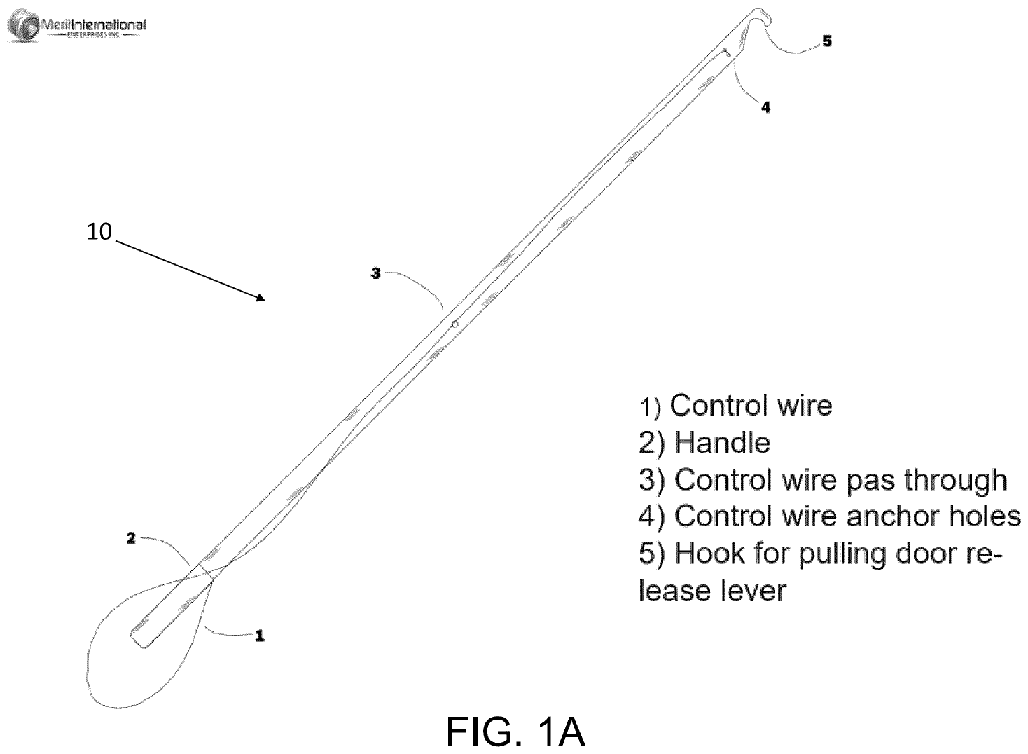

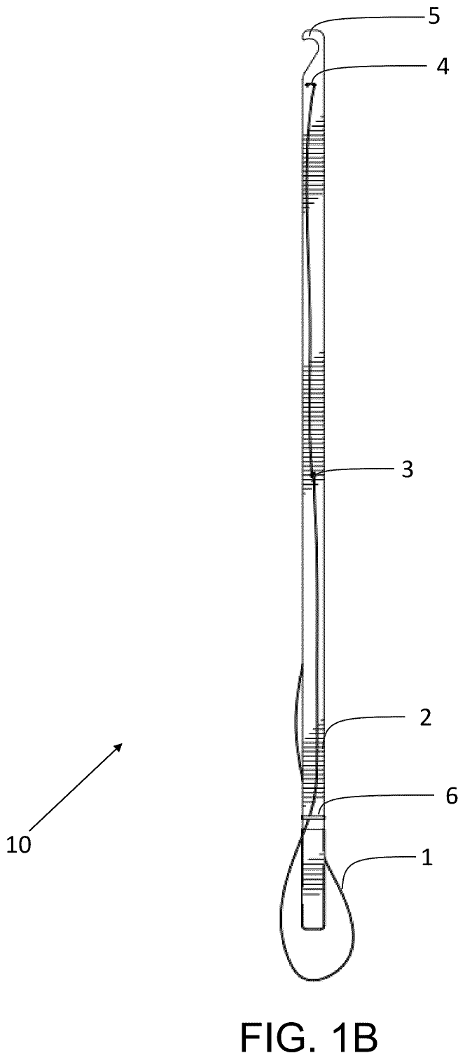

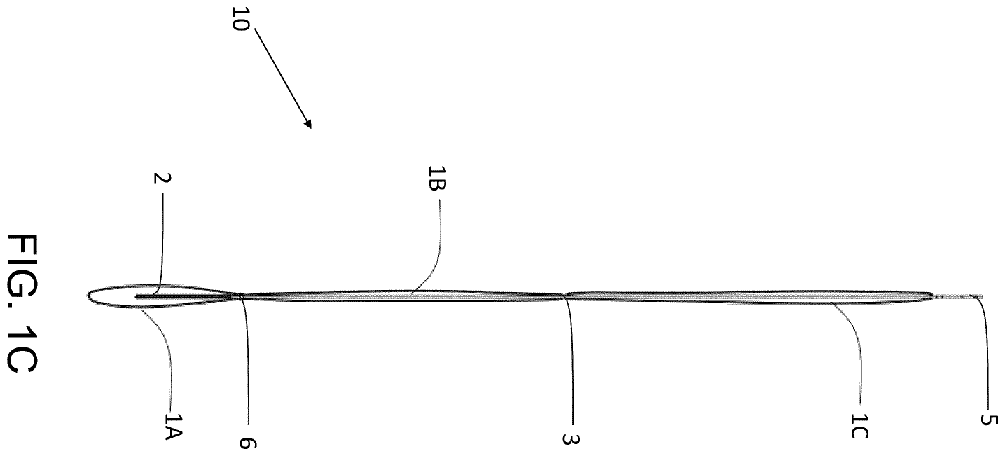

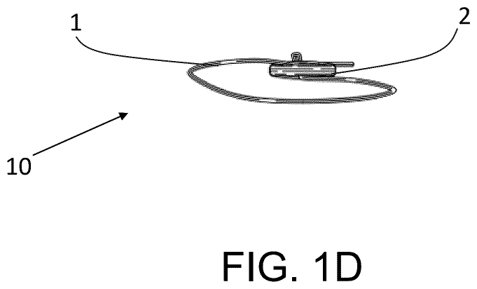

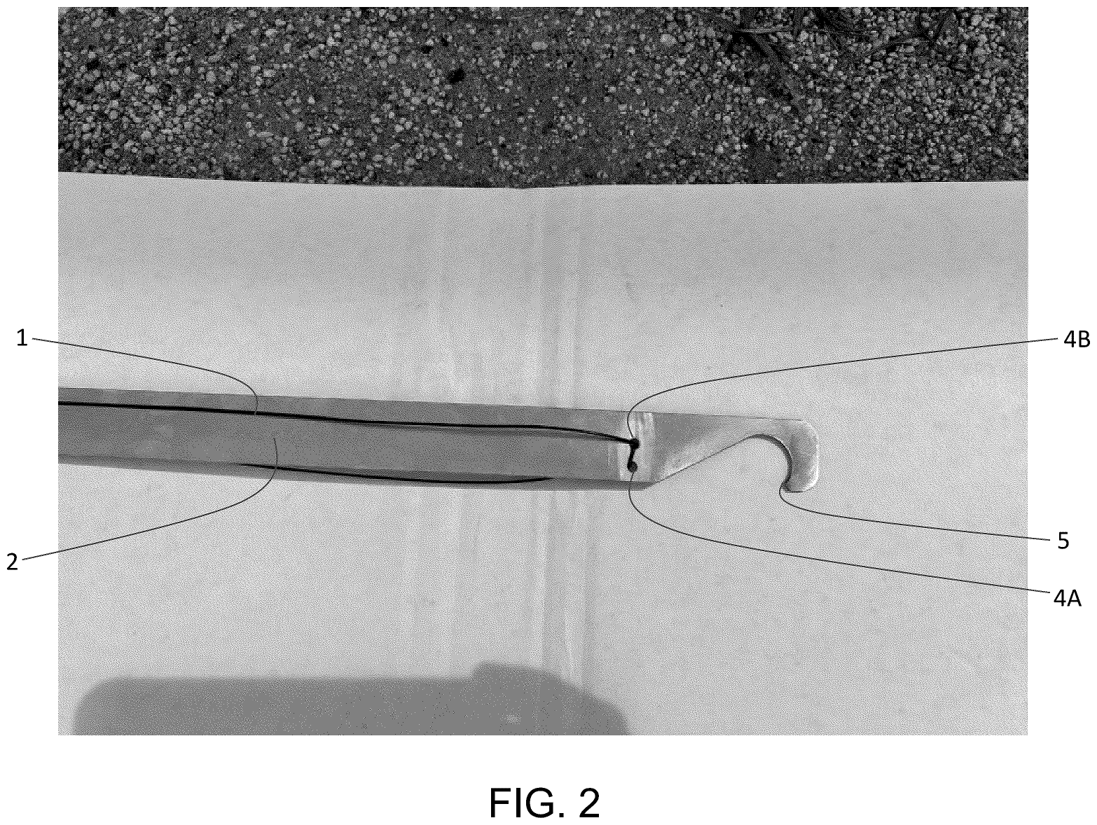

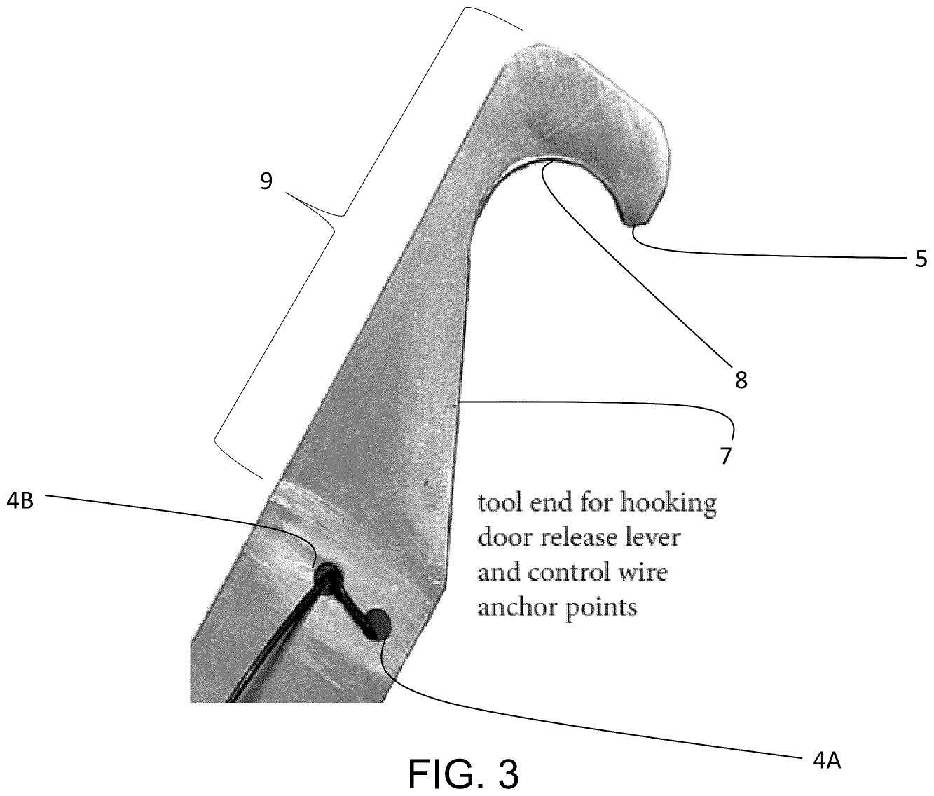

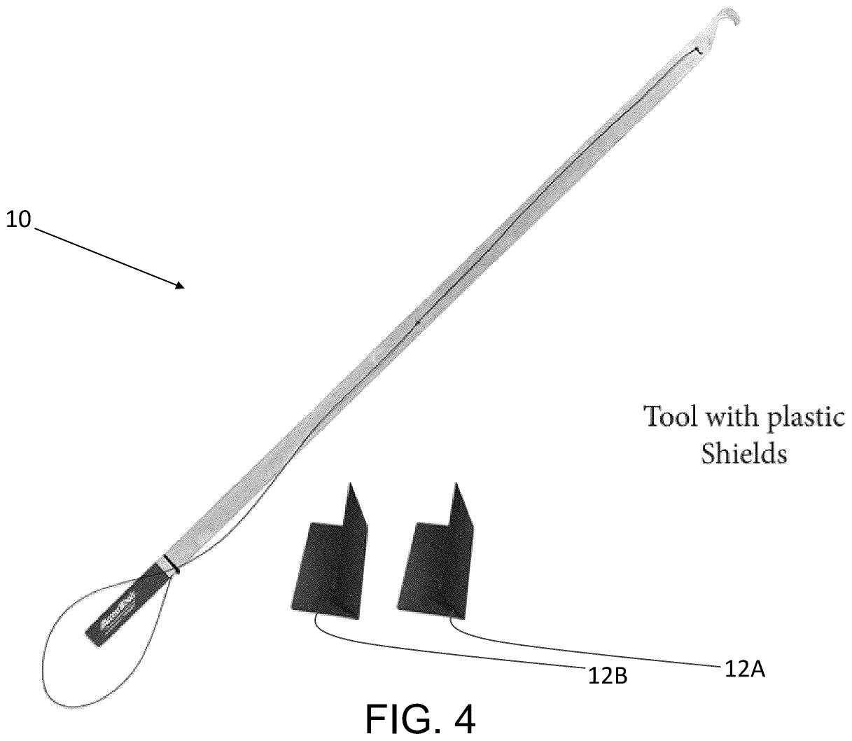

Turning now to the Drawings, FIGS. 1A-1D shows a unlocking tool 10 implemented as an elongated thin strip of material. The unlocking tool is controlled by a control wire 1 operatively connected to the elongated strip at its distal end at a pair of control wire anchor holes 4. The control wire 1 spans from the distal end of the tool at its anchor holes 4 at the distal end through a hole 3 at the tool's midportion and terminates at a loop at the proximate end of the tool which serves as a handle 2. A hole 3 at the tool's midportion and a ring 6 at the tool's distal end allow the control wire 1 to be threaded as multiple loops. Such loops are shown in FIG. 1C where a first loop 1A is formed at the tool's proximate end by ring or band 6 which restricts control wire to run adjacent to handle 2 and second 1B and third 1C loops which span either side of hole 3 such that the control wire is threaded through hole 3 to cross over to the opposite sides of the elongated strip before terminating at the distal end. The first loop 1A at the user or operator end (proximate end) allows control of the tip of the tool such that pulling on the control wire on the right side of tool at the proximate or user-controlled end of the tool causes the wire attached at the distal end on the left side to shorten (due to the control wire 1 crossing over to the opposite side of the tool at hole 3) thereby causing the distal end to bend toward the left, and vice versa. At the end opposite to the handle 2 (i.e., the distal end) the unlocking tool terminates at a hook portion 5 which is designed to latch and pull open a door release lever on automotive vehicles with frameless windows including TESLA® vehicles. The distal end is shown in magnified view at FIGS. 2 and 3, which show the control wire 1 passing through anchor holes 4A and 4B before the tool terminates at the tool end 9 which includes a tapered portion 7 which is adjacent to concave indentation 8 which then terminates at the hook 5 designed to latch onto the vehicle's release lever. FIG. 4 shows the tool 10 can be provided as part of a kit which includes a pair of plastic shields 12A and 12B the function of which will be apparent in subsequent drawings. The body of the unlocking tool can be fabricated from sheet metal such as steel or from a metallic alloy such as aluminum, or from a hard flexible plastic. The body is dimensioned to have a thickness that can be fitted within a space between a glass window and weatherstripping of a door frame of the vehicle and a length which can be inserted into the vehicle to reach the manual release lever while providing a portion outside the vehicle to allow for hand manipulation of the tool. The control wire can be a thin gauge metal or metallic wire that can be threaded into anchor holes 4A and 4B and midportion hole 3. A hard flexible plastic polymer such as nylon line or a thin cord or string (cord and string used interchangeably herein) of tightly-woven material such as a polyester and/or cotton can also be used instead of a metal or metallic wire.

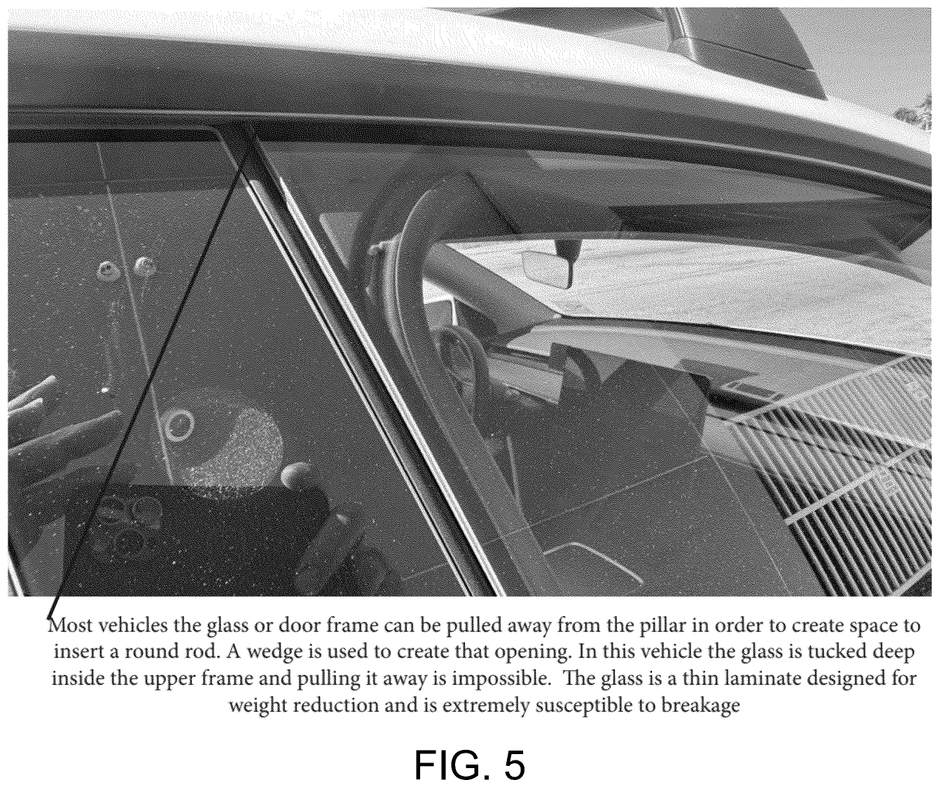

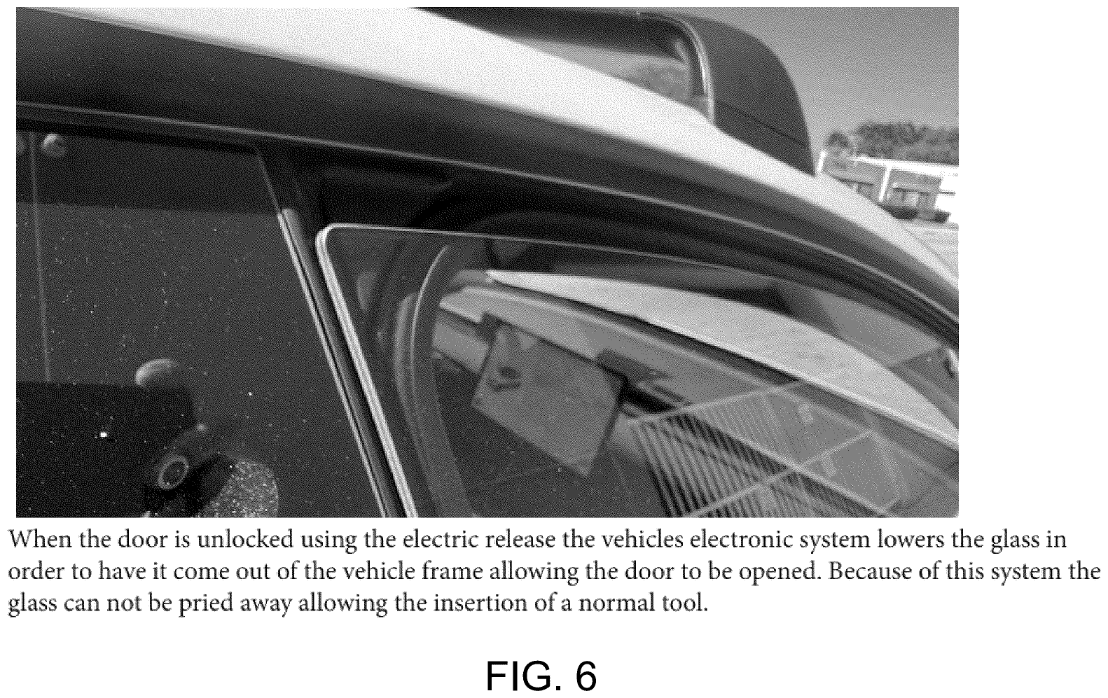

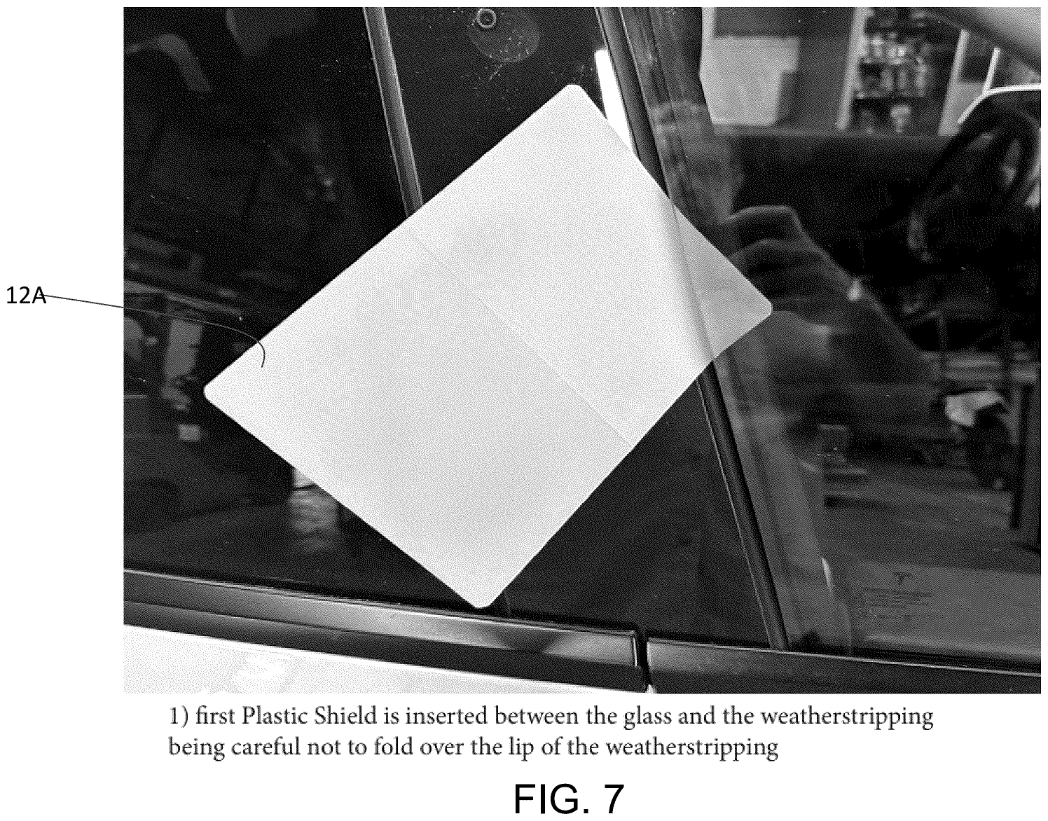

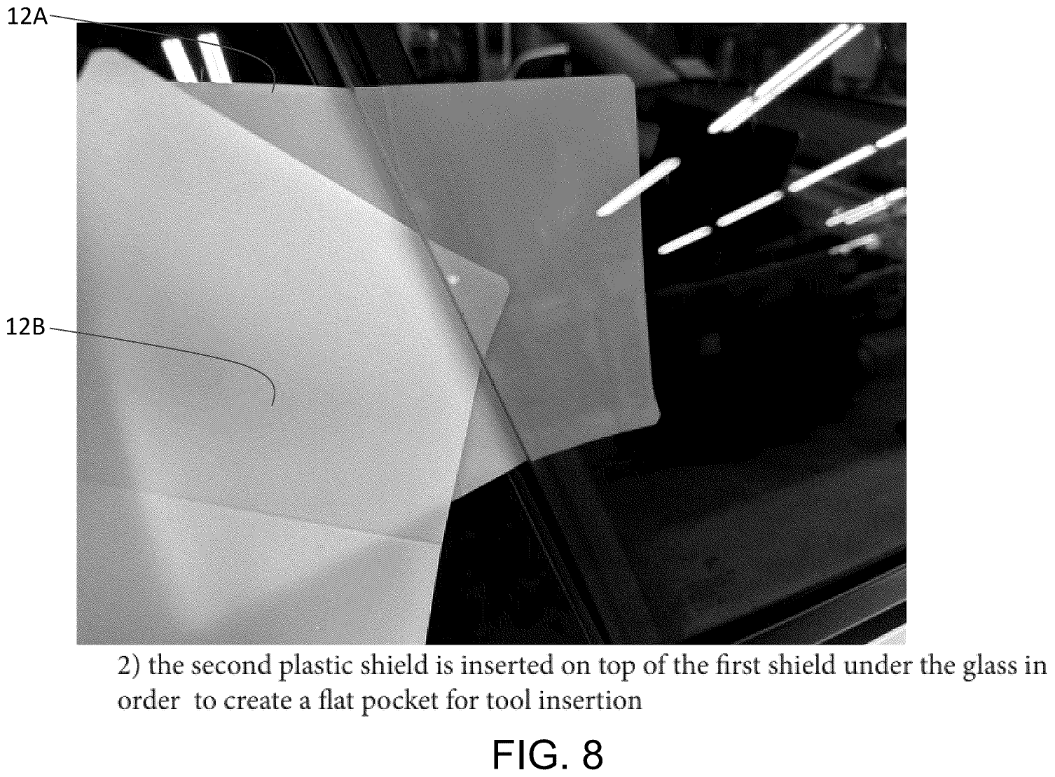

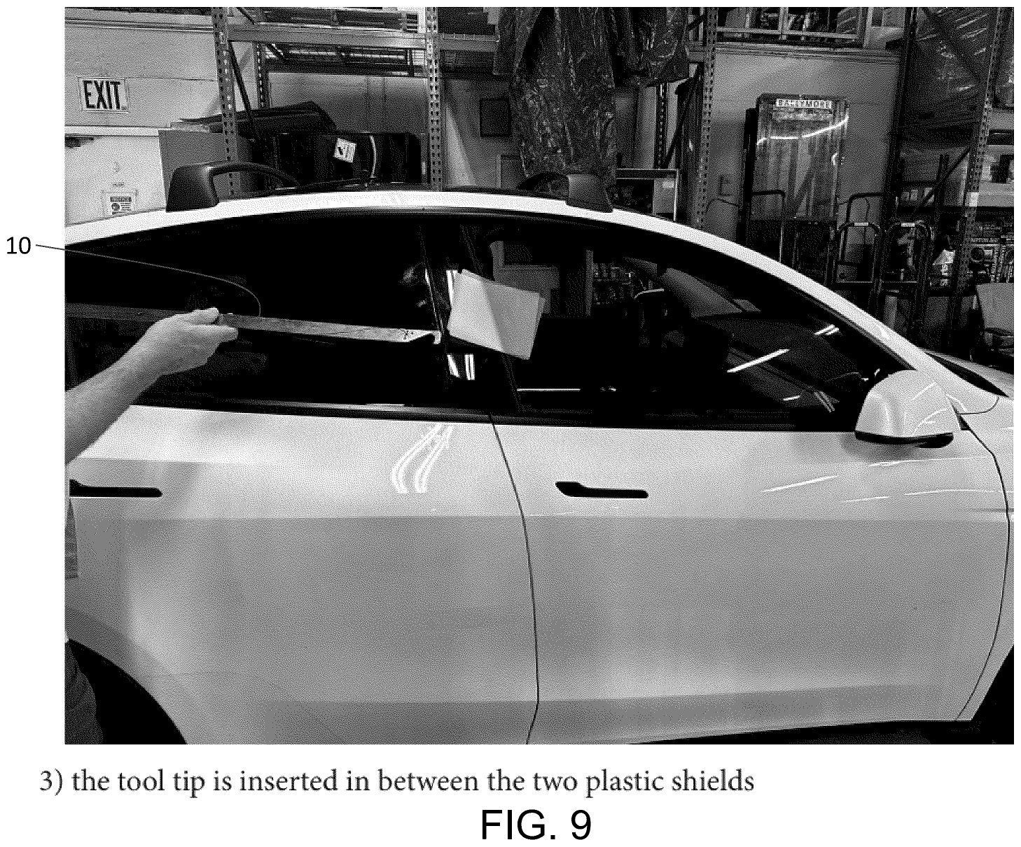

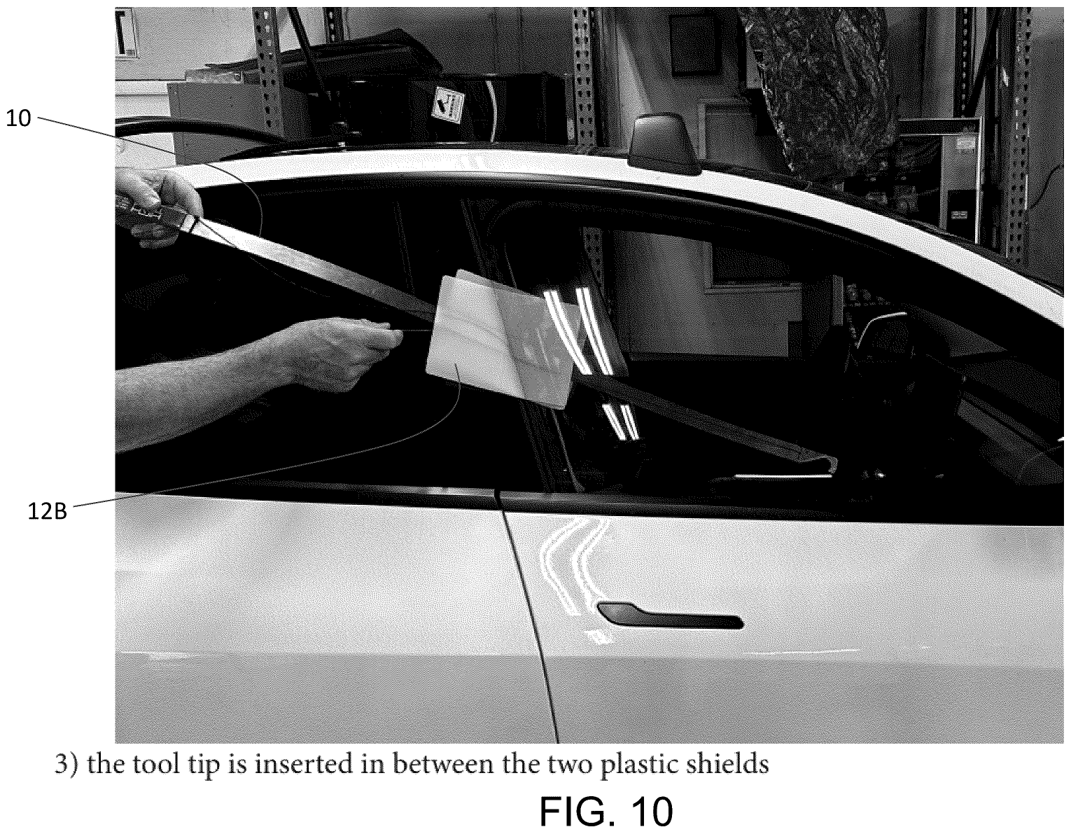

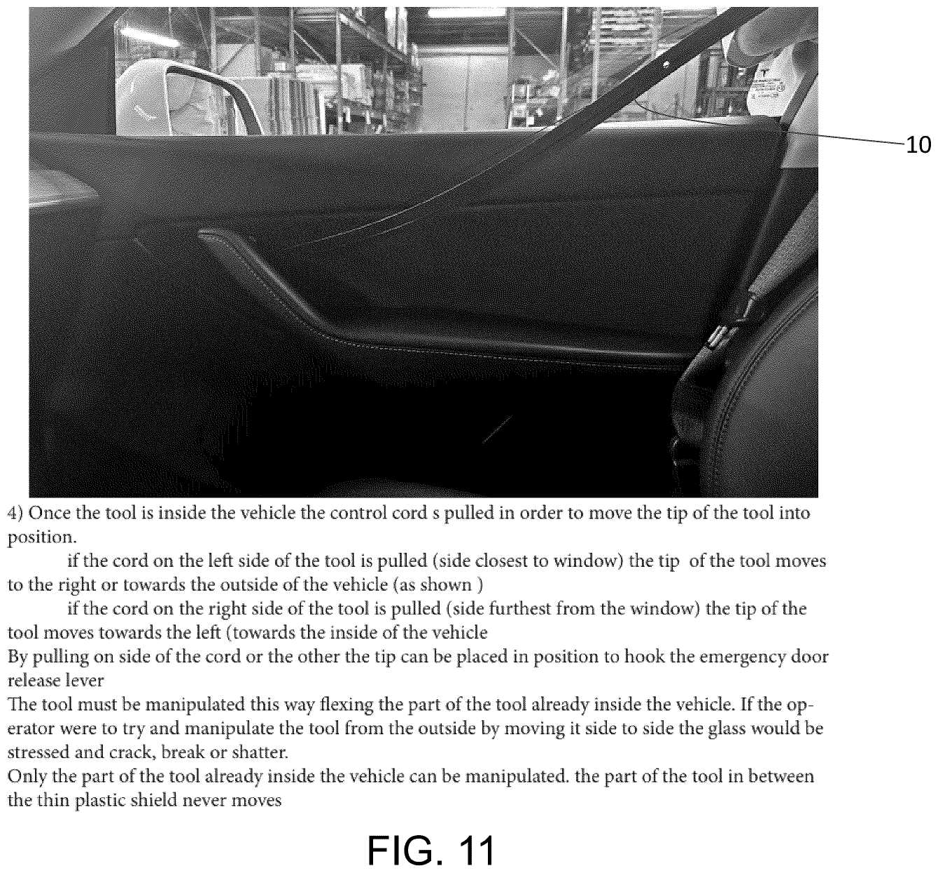

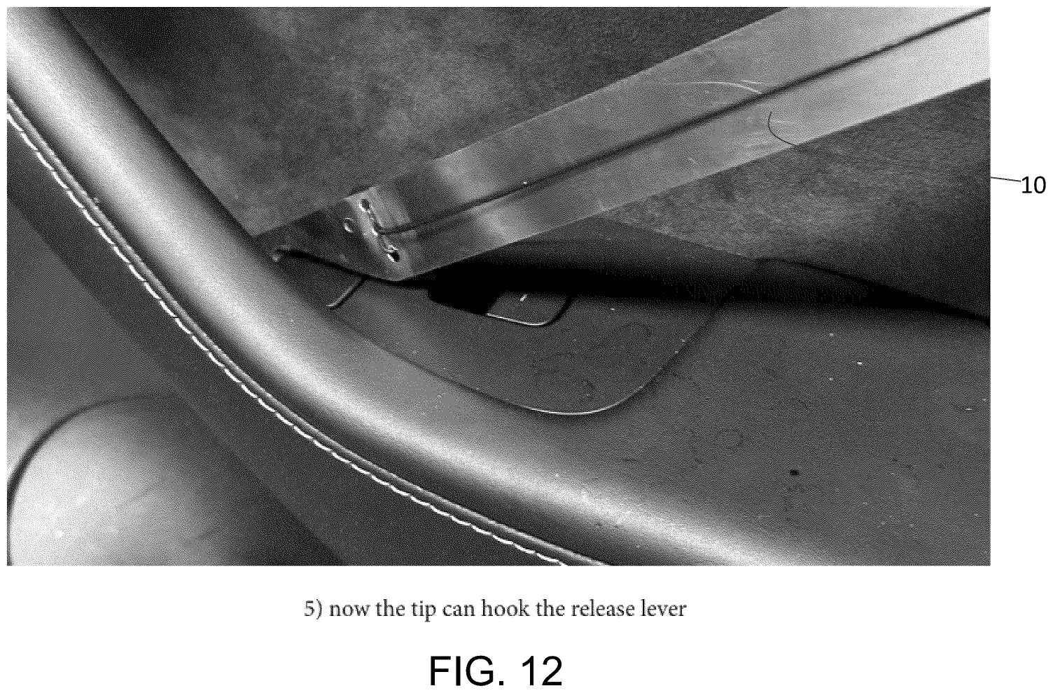

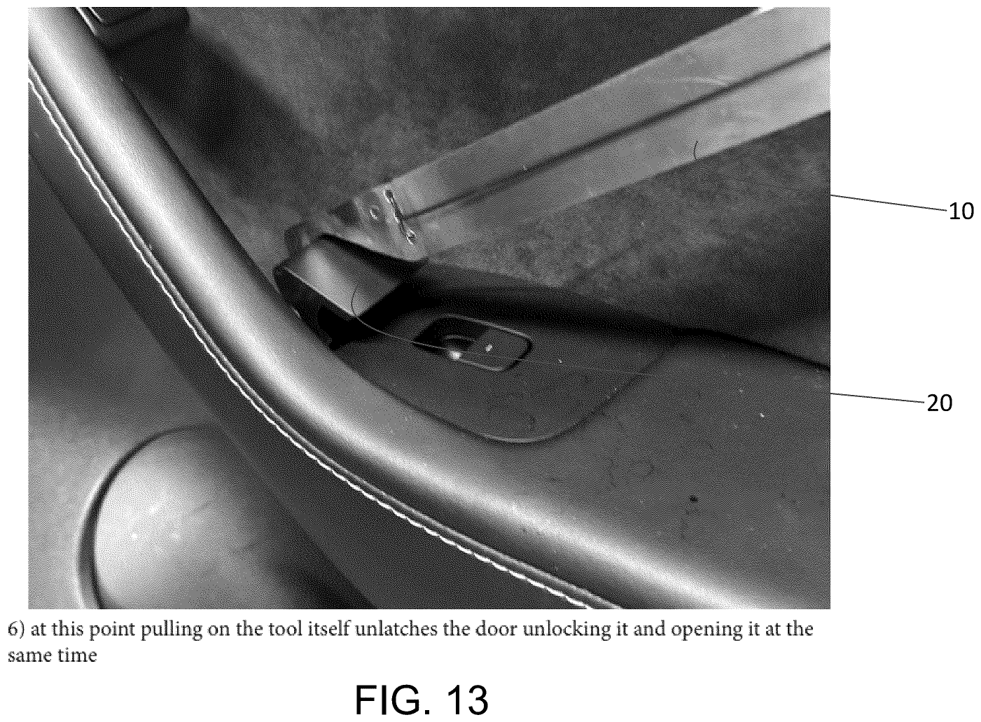

The remaining Drawings FIGS. 5-15 illustrate the use of the unlocking tool 10. Most vehicles will have a glass window or door frame that can be pulled away from the pillar in order to create space to insert a round rod. However, as shown in FIG. 5, the glass window in the vehicle is tucked deep inside the upper frame of the door and pulling it away is impossible. This is compounded by the glass of the window being made of a thin laminate designed for weight reduction and thus extremely susceptible to breakage. As depicted in FIG. 6, when the door is unlocked using the electric release the vehicles electronic system lowers the glass in order to have it come out of the vehicle frame allowing the door to be opened. Because of this system, the glass cannot be pried away to allow the insertion of a conventional tool. The solution that the unlocking tool provides is depicted as follows. As FIG. 7 shows, a first plastic shield 12A is inserted between the glass and the weatherstripping without folding over the lip of the weatherstripping. A second plastic shield 12B is inserted on top of the first shield 12A under the glass in order to create a flat pocket for tool insertion, as depicted in FIG. 8. The plastic shields also prevent direct contact of the metal tool 10 with the fragile glass of the window. The tool tip is inserted between the two plastic shields, as shown in FIGS. 9 and 10. Operation of the tool 10 once the distal portion of the tool 10 is inside the vehicle is shown at FIG. 11. Once the tool is inside the vehicle the control wire, line, or cord is pulled in order to move the tip of the tool into position. If the control wire, line, or cord on the side closest to the window is pulled (left side of portion of tool outside the vehicle controlled by the operator), the tip of the tool moves towards the outside of the vehicle, or to the right (as shown). If the control wire, line, or cord on the side furthest from the window is pulled (right side of portion of tool outside the vehicle controlled by the operator), the tip of the tool moves toward the inside of the vehicle, or to the left. By pulling on either side of the control wire, line, or cord, the tip can be placed into position to hook the emergency release lever. The tool is manipulated this way, flexing the portion of the tool that is inside the vehicle. If the operator were to try and manipulate the tool from the outside by moving it side-to-side the glass would be stressed and crack, break, or shatter. Only the part of the tool already inside the vehicle can be manipulated, as the part of the tool in between the thin plastic shield never moves. FIG. 12 shows the hook 5 of the tool 10 successfully guided into position to hook onto the release lever, while FIG. 13 shows that pulling on the handle of the tool 10 causes the release lever 20 to open thereby unlocking and opening the door at the same time.

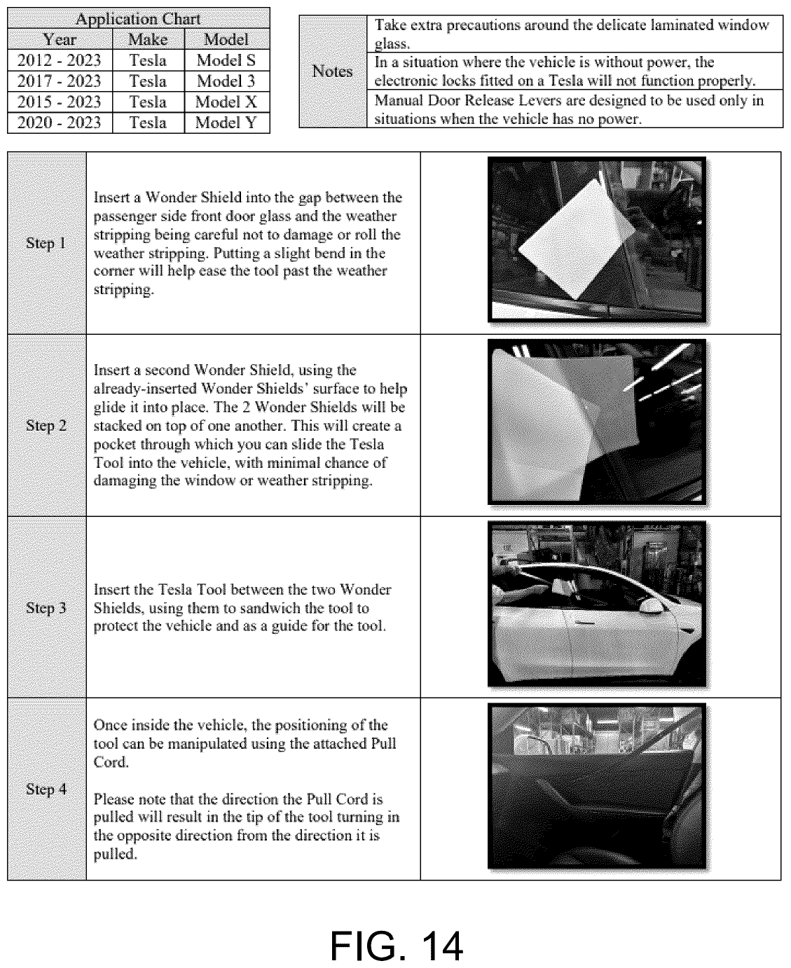

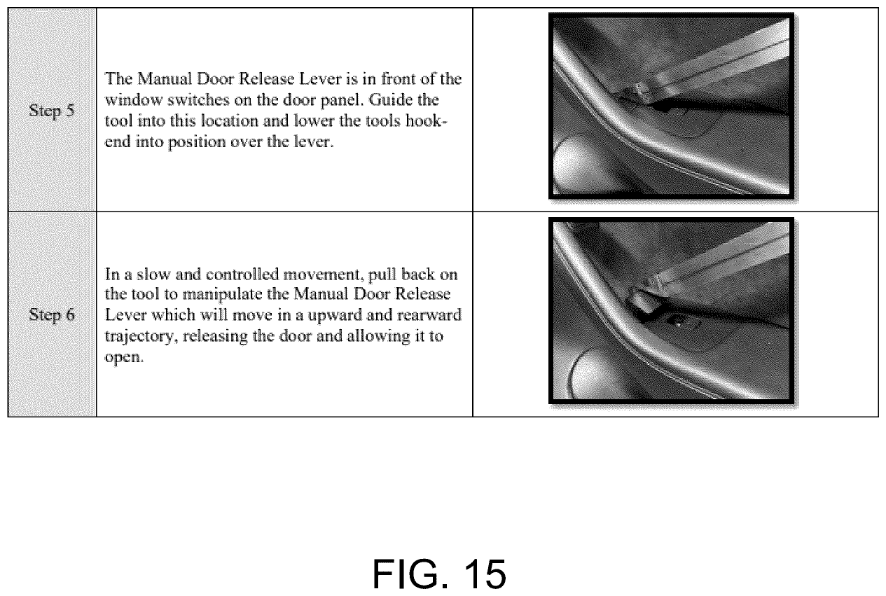

FIGS. 14 and 15 depict a set of instructions for using the unlocking tool according to the process described in the previous figures. As shown at the top left of FIG. 14, the unlocking tool is designed to fit automotive vehicles with frameless windows including TESLA® Models S, 3, X, and Y. At step 1, the user is instructed to insert a shield into the gap between the passenger side front door glass and the weather stripping being careful not to damage or roll the weather stripping. The user is instructed to put a slight bend in the corner of the shield to help ease the tool past the weather stripping. At step 2, the user is instructed to insert a second shield using the already-inserted shield's surface to help glide it into place. The two shields are stacked on top of one another. This creates a pocked through which the user can slide and insert the unlocking tool into the vehicle, with minimal chance of damaging the window or weather stripping. At step 3, the user is instructed to insert the unlocking tool between the two shields, using them to sandwich the tool to protect the vehicle and serve as a guide for the tool. At step 4, once the distal end of the tool is inside the vehicle, the positioning of the tool can be manipulated using the attached control wire, line, or pull cord. The direction the pull cord is pulled will result in the tip of the tool turning in the opposite direction from the direction it is pulled. At step 5, the manual door release lever is in front of the window switch on the door panel. The user is instructed to guide the tool into this location and lower the tool's hook end into position over the lever. At step 6, the user is instructed to pull back on the tool in a slow and controlled movement to manipulate the manual door release lever which will move in an upward and rearward trajectory, releasing the door and allowing it to open.

It should be noted at this point that orientational terms such as proximate, distal, left, and right refer to the subject tool as used by an operator or user. The drawing figures depict their subject matter in orientations of normal use, which could obviously change with changes in posture and position of the tool not used conventionally. Therefore, orientational terms must be understood to provide semantic basis for purposes of description, and do not limit the invention or its component parts in any particular way.

The present disclosure has described particular implementations having various features. In light of the disclosure provided above, it will be apparent to those skilled in the art that various modifications and variations can be made without departing from the scope or spirit of the disclosure. One skilled in the art will recognize that the disclosed features may be used singularly, in any combination, or omitted based on the requirements and specifications of a given application or design. When an implementation refers to “comprising” certain features, it is to be understood that the implementations can alternatively “consist of” or “consist essentially of” any one or more of the features. Other implementations will be apparent to those skilled in the art from consideration of the specification and practice of the disclosure.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the disclosure fall within the scope of the disclosure. Further, all of the references cited in this disclosure including patents, published applications, and non-patent literature are each individually incorporated by reference herein in their entireties and as such are intended to provide an efficient way of supplementing the enabling disclosure as well as provide background detailing the level of ordinary skill in the art.

1. A tool designed to manually unlock a vehicle from control from the outside of the vehicle, the tool comprising:
an elongated strip of material having an operator proximate end and terminating at a hook at a distal end; and
a control wire, cord, or line operatively connected to the elongated strip of metallic material at the distal end that causes the distal end to bend when pulled at the operator proximate end.

2. The tool of claim 1, wherein the control wire, cord, or line is operatively connected in a manner such that an operator can cause the distal end of the elongated strip of material to bend toward an opposite side of the elongated strip of material to which the control wire, cord, or line is pulled.

3. The tool of claim 1, wherein the control wire, cord, or line is threaded through a hole in a midportion of the elongated strip of material such that the control wire, cord, or line crosses over from a first side toward an opposite side of the elongated strip of material.

4. The tool of claim 1, wherein the control wire, cord, or line terminates at a pair of anchor holes at the distal end of the elongated strip of material before the hook.

5. The tool of claim 1, wherein the control wire, cord, or line forms a loop at the proximate end of the elongated strip of material.

6. The tool of claim 1, wherein the elongated strip of material has a thickness dimensioned to fit within a space between a glass window and weatherstripping of a door frame of the vehicle.

7. The tool of claim 1, wherein the elongated strip of material has a length dimensioned to allow a user to operate the proximate end of the elongated strip of material outside a locked vehicle while controlling the distal end to reach the manual door release lever inside the locked vehicle.

8. The tool of claim 1, wherein the elongated strip of material comprises metal or a metal alloy.

9. A kit comprising the tool of claim 1, first and second plastic shields having a thickness dimensioned to fit together with the tool within a space between a glass window and weatherstripping of a door frame of the locked vehicle, and optionally written instructions for operating the kit.

10. A method of unlocking a vehicle, comprising:
inserting the first and second plastic shields of the kit of claim 9 within the space between the glass window and weatherstripping of the door frame of the locked vehicle;
inserting the tool of the kit of claim 7 between the first and second plastic shields such that the distal end of the tool enters inside the vehicle while the operator proximate end remains outside the vehicle; and
operating the proximate end of the tool to cause the distal end to engage the manual release lever; and
pulling the proximate end of the tool to cause the manual release lever to unlatch.

11. The method of claim 10, wherein operating the proximate end comprises pulling the control wire, cord, or line on a left side of the proximate end of the tool to cause the distal end of tool to bend toward the right.

12. The method of claim 10, wherein operating the proximate end comprises pulling the control wire, cord, or line on the right side of the proximate end of the tool to cause the distal end of the tool to bend toward the left.
